(19) United States
(12) Patent Application Publication
(10) Pub. No.: US 2006/0080723 A1
(43) Pub. Date: Apr. 13, 2006

(54) System and method for enabling TV and computer to process digital audio/video signal simultaneously

(75) Inventor: Joseph Shev, Taipei Hsien (TW)

Correspondence Address: BRUCE H. TROXELL, SUITE 1404, 5205 LEESBURG PIKE, FALLS CHURCH, VA, 22041, US

(73) Assignee: THP Technology Co., Ltd.

(21) Appl. No.: 11/041,975

(22) Filed: Jan. 26, 2005

(30) Foreign Application Priority Data
Oct. 12, 2004 (TW) 93130804

(51) Int. Cl. H04N 7/16; H04N 7/173

(52) U.S. Cl. 725/131; 725/100; 725/151

(57) ABSTRACT

The present invention discloses a system and method for enabling a TV and a computer to process a digital audio/video signal simultaneously, wherein the output path of the received digital audio/video signal is controlled by the TS buffer and the digital audio/video signal is decoded by the digital video decoder module for use in the TV. The USB controller is adopted as a transmission interface so as to output the digital audio/video signal for use in the computer. Accordingly, the TV and the computer are capable of processing the digital audio/video signal simultaneously by means of a single machine operation, the system, and the method for facilitating the application of the digital audio/video signal to the TV and the computer.

### FIELD OF THE INVENTION

The present invention relates to a system and method for processing a digital audio/video signal, and more particularly to a system and method for enabling a TV and a computer to process a digital audio/video signal simultaneously.

### BACKGROUND OF THE INVENTION

The typical household television (TV), i.e. the so-called analog TV, uses the NTSC system, by which the variation of the screen signal is continuous. On the other hand, the signal employed by the digital TV is digitized so as to convert the signal into a string of data before it is provided for the digital TV.

The screen signal employed by the existing digital TV is a digital audio/video signal of MPEG-2 compression format. This digital audio/video signal is capable of transmitting a HDTV (High-Definition TV) screen with 1080 horizontal scan lines in the 6M HZ bandwidth TV channel provided by the conventional wireless TV station, wherein the HDTV screen is more exquisite and colorful than the conventional TV screen with 525 horizontal scan lines. Moreover, the digital TV also provides the Dolby AC3 audio effect.

In comparison with the conventional analog audio/video signal, the digital audio/video signal can transmit larger amount of data on the basis of identical bandwidth. Accordingly, the scan frequency of a displayed image supported by the digital audio/video signal can be largely increased, and thus the quality of the displaying image is increased. Moreover, digital audio/video signal is more stable and lesser vulnerable to exterior environment during the transmission of the digital audio/video signal. Consequently, the image supported by the digital audio/video signal will not suffer the phenomena of ghost image, blurred image, and flickered image as often as the conventional analog TV. Besides, the digitalized audio/video signal can be provided for computers and digital consumer products so that enables the combination of those produce and thus facilitate the same to be more user friendly.

Therefore, it is obvious that the digital audio/video signal is going to replace the analog audio/video signal as the upcoming standard of signal transmitting and receiving. Accordingly, for displaying images of digital audio/video signal on the existing analog TV, a Set-Top-Box (STB) is required to be installed in the analog TV. Furthermore, while intending to display images of digital audio/video signal on a computer, another kind of STB specialized fro receiving the same is required to be installed in the computer.

Nevertheless, the existing designs of the STB are specialized either for the analog TVs or computers. That is, the STB specialized for analog TV can only be used for display images of digital audio/video signal on the analog TVs, but not on computers, and vice versa. There is no universal STB adapted for displaying images of digital audio/video signal on both the analog TVs and computers.

In view of the above description, the present invention discloses a system and method for enabling a TV and a computer to process a digital audio/video signal simultaneously. In accordance with the present invention, the TV and the computer are capable of processing the digital audio/video signal simultaneously such that the TV and the computer can utilize the digital audio/video signal simultaneously for facilitating the application of the digital audio/video signal to the TV and the computer.

### SUMMARY OF THE INVENTION

It is the primary object of the invention to provide a system for enabling a TV and a computer to process a digital audio/video signal simultaneously, the system comprising: a receiving device, for receiving a digital audio/video signal and controlling the same to be outputted to a TV and/or a computer; and a decoding device, for decoding the digital audio/video signal so as to be displayed on the TV.

In the preferred embodiment of the present invention, the receiving device further comprises: an output controller, for transmitting the digital audio/video signal between the receiving device and the computer; and a transport stream (TS) buffer, for receiving the digital audio/video signal so as to output the same between the decoding device and the output controller, wherein the output controller is a USB (Universal Serial Bus) controller according to a preferred embodiment of the invention.

The system of the present invention may be applied to various types of TV and computer. For example, the TV can be a plasma TV or a LCD (Liquid Crystal Display) TV, and the computer can be a desktop computer or a notebook computer.

Furthermore, in order to achieve the objects described above, the present invention also provides a method for enabling a TV and a computer to process a digital audio/video signal simultaneously, the method comprising the steps of: using a TS buffer for controlling the digital audio/video signal to be outputted to the TV and/or the computer; using a digital video decoder module (DVDM) for decoding the digital audio/video signal before it is outputted to the TV; and using a USB controller to control the transmission of the digital audio/video signal between the TS buffer and the computer.

In the preferred embodiment of the present invention, the system applying the method comprises a plurality of operation modes. In an independent STB mode, the computer is not connected to the system where the digital audio/video signal is received by the digital tuner and then outputted from the TS buffer to the DVDM for enabling the same to be decoded so as to be outputted to the TV. In an independent computer receiver mode, the TV is not connected to the system where the digital audio/video signal outputted from the TS buffer is outputted to the computer through the USB controller so as to display the digital audio/video signal by means of the software of the computer. In a co-manipulation mode, the digital audio/video signal is outputted from the TS buffer to the TV and the computer simultaneously. In a playback mode, the digital audio/video signal stored in the computer is outputted to the TV by means of the TS buffer, the DVDM and the USB controller.

### BRIEF DESCRIPTION OF THE DRAWINGS

FIG. 1 illustrates a schematic circuit diagram of a system enabling a TV and a computer to process a digital audio/video signal simultaneously.

### DESCRIPTION OF THE PREFERRED EMBODIMENT

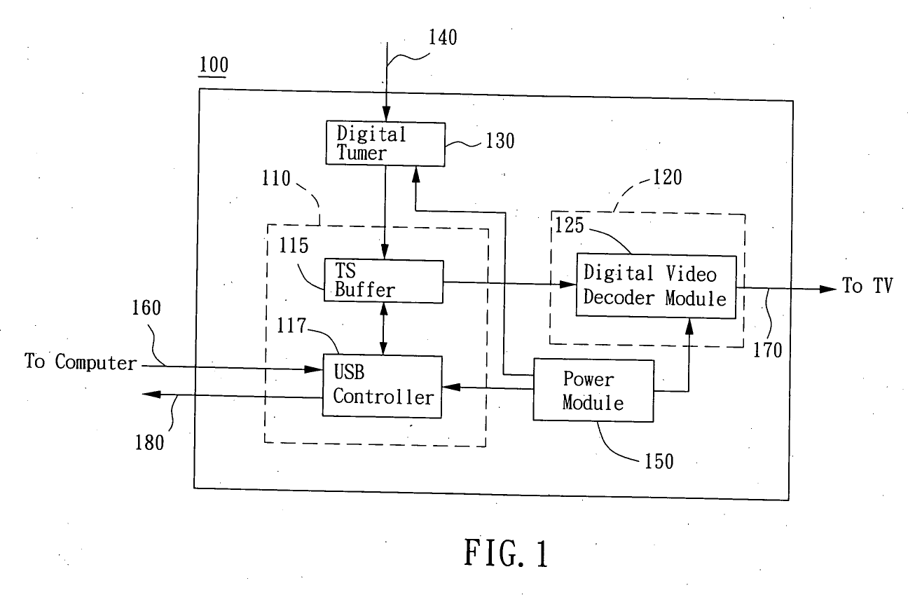

FIG. 1 illustrates a schematic circuit diagram of a system for enabling a TV and a computer to process a digital audio/video signal simultaneously in accordance with the present invention. This system 100 primarily comprises a receiving device 110 and a decoding device 120, wherein the receiving device 110 is composed of a TS buffer 115 for controlling the flow direction of a signal and a USB controller 117 for controlling the input/output of a computer, and the decoding device 120 is a digital video decoding module (DVDM) 125.

Moreover, the system 100 further comprises a digital tuner 130 for receiving a digital audio/video signal 140, which is, for example, transmitted from a TV station (not shown) by means of microwave, and a power module 150 for supplying power to partial devices mounted inside the system 100.

Accordingly, the system 100 is able to receive the digital audio/video signal 160 inputted from a computer by means of the USB controller 117 or receive the digital audio/video signal 140 emitted from the TV station by means of the digital tuner 130. The digital audio/video signals 140 and 160 received by the system 100 are respectively inputted into the TS buffer 115 directly or through the USB controller 117. The flow directions of the digital audio/video signals 160 and 140 are controlled by the TS buffer 115 where it is directed to flow either toward a TV through the digital video decoder module 125, or toward the computer through the USB controller 117, after the TS buffer 115 receives the digital audio/video signal 160 or the digital audio/video signal 140.

Consequently, no matter the system 100 receives the digital audio/video signal 140 from the TV station or the digital audio/video signal 160 from the computer, the system 100 is capable of enabling the digital video decoder module 125 to perform the decoding operation so as to output a TV signal 170 for use in the TV, or enabling the USB controller 117 to output a USB signal 180 for use in the computer by means of the control of the TS buffer 115.

Therefore, the TS buffer 115 of the system 100 can determine whether to output the digital audio/video signal 170 to a TV or to output the digital audio/video signal 180 to a computer. Moreover, by use of the digital video decoder module 125, the digital audio/video signal 160 or the digital audio/video signal 180 is decoded for outputting a decoded signal to the TV, and, by use of the USB controller 117, the digital audio/video signal 140 or the digital audio/video signal 180 is transmitted from the TS buffer 115 to the computer. The system 100 enables the TV and the computer to use the digital audio/video signal simultaneously so as to provide the TV and the computer with the function of processing the digital audio/video signal 140 or the digital audio/video signal 160 simultaneously.

For the purpose of use, the system 100 provides various operation modes, for example, an independent set-top box (STB) mode, an independent computer receiver mode, a co-manipulation mode, a playback mode, etc. In the independent set-top box mode, the computer is not connected to the system 100 where the digital audio/video signal 140 is received by the digital tuner 130 and then outputted from the TS buffer 115 to the DVDM 125 for enabling the same to be decoded so as to be outputted to the TV.

In an independent computer receiver mode, the TV is not connected to the system 100 where the digital audio/video signal 140 outputted from the TS buffer 1 15 is outputted to the computer through the USB controller 117 so as to display the digital audio/video signal by means of the software of the computer.

In the co-manipulation mode, the digital audio/video signal 140 outputted from the TS buffer 115 is transmitted through the digital video decoder module 125 for use in the TV and the USB controller 117 for use in the computer simultaneously. In this co-manipulation mode, the computer terminal is capable of recording the digital audio/video signal 140 when the TV terminal is showing the digital audio/video signal 140.

In the playback mode, the digital audio/video signal 140 stored in the computer terminal, for example, in the co-manipulation mode, or the digital audio/video signal 160 stored additionally in the computer is outputted to the TV through the TS buffer 115 and the digital video decoder module 125 by means of the USB controller 117.

As described above, the present invention discloses a system and method to enable a TV and a computer to process a digital audio/video signal simultaneously, wherein the output path of the received digital audio/video signal is controlled by the TS buffer and the digital audio/video signal is decoded by the digital video decoder module for use in the TV. The USB controller is adopted as a transmission interface so as to output the digital audio/video signal for use in the computer. Accordingly, the TV and the computer are capable of processing the digital audio/video signal simultaneously by means of a single machine operation, the system, and the method for facilitating the application of the digital audio/video signal to the TV and the computer.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What is claimed is:

1. A system for enabling a TV and a computer to process a digital audio/video signal simultaneously, comprising:
a receiving device, for receiving a digital audio/video signal and controlling the same to be outputted to a TV and/or a computer; and
a decoding device, for decoding the digital audio/video signal so as to be displayed on the TV.

2. The system of claim 1, wherein the receiving device further comprises:
an output controller, for controlling the digital audio/video signal to be transmitted between the receiving device and the computer; and
a transport stream (TS) buffer, for receiving the digital audio/video signal so as to output and enable the same to be transmitted between the decoding device and the output controller.

3. The system of claim 2, wherein the output controller is a universal serial bus (USB) controller.

4. The system of claim 2, further comprising:
a digital tuner, for receiving the digital audio/video signal and then outputting the same to the TS buffer.

5. The system of claim 1, further comprising:
a power module, for supplying power to the receiving device and the decoding device.

6. The system of claim 1, wherein the decoding device is a digital video decoder module (DVDM).

7. The system of claim 6, wherein digital audio/video signal module decodes and converts the digital audio/video signal into an audio signal and a visual signal, and outputs the audio signal and the visual signal to the TV for playing.

8. The system of claim 1, wherein the TV is a plasma TV.

9. The system of claim 1, wherein the TV is a LCD TV.

10. The system of claim 1, wherein the computer is a desktop personal computer.

11. The system of claim 1, wherein the computer is a notebook computer.

12. A method for enabling a TV and a computer to process a digital audio/video signal simultaneously, comprising:
using a transport stream (TS) buffer to control the output of the digital audio/video signal to the TV and/or the computer;
using a digital video decoder module (DVDM) for decoding the digital audio/video signal before it is outputted to the TV; and
using a USB controller to control the transmission of the digital audio/video signal between the TS buffer and the computer.

13. The method of claim 12, further comprising:
using a digital tuner to receive the digital audio/video signal and then transmit the same to the TS buffer.

14. The method of claim 13, wherein the method operating in an independent Set-Top-Box mode is characterized in that: the computer is not connected and the digital audio/video signal is received by the digital tuner and then outputted from the TS buffer to the DVDM for enabling the same to be decoded so as to output a decoded signal to the TV.

15. The method of claim 12, wherein the method operating in an independent computer receiver mode is characterized in that: the TV is not connected and the digital audio/video signal outputted from the TS buffer is outputted to the computer through the USB controller so as to display the digital audio/video signal by means of the software of the computer.

16. The method of claim 12, wherein the method operating in a co-manipulation mode is characterized in that: the digital audio/video signal is outputted from the TS buffer to the TV and the computer simultaneously

17. The method of claim 12, wherein the computer is capable of recording the digital audio/video signal when the TV is showing the digital audio/video signal.

18. The method of claim 12, wherein the method operating in a playback mode is characterized in that: the digital audio/video signal stored in the computer is outputted to the TV by means of the TS buffer, the DVDM and the USB controller.
